(19) United States
(12) Patent Application Publication
(10) Pub. No.: US 2026/0243625 A1
(43) Pub. Date: Aug. 20, 2026

(54) ESCALATOR AND MOVING HANDRAIL FORCE IMPEDANCE TOOL

(71) Applicant: KONE Corporation, Helsinki (FI)

(72) Inventors: Alan CLARKE, JR., Moline, IL (US); Julian JUSTIN, Silvis, IL (US)

(73) Assignee: KONE Corporation, Helsinki (FI)

(21) Appl. No.: 19/056,462

(22) Filed: Feb. 18, 2025

(51) Int. Cl. G01M 13/022; B66B 31/02; G01L 5/00

(52) U.S. Cl. CPC G01M 13/022; B66B 31/02; G01L 5/0038; G01L 5/0071

(57) ABSTRACT

A moving handrail impedance tool tests an escalator or moving walkway. The moving handrail impedance tool may include a main frame and a first wheel assembly and a second wheel assembly mounted on the main frame. The first wheel assembly may include a first contact wheel having a handrail contact surface and a second contact wheel having a handrail contact surface. A first brake impedes rotation of the first contact wheel and the second contact wheel caused by contact of the wheels with the first side of the handrail. The second wheel assembly may include a third contact wheel and a fourth contact wheel having a handrail contact surface for contacting the handrail. A second brake impedes rotation of the third contact wheel and the fourth contact wheel.

### BACKGROUND OF THE INVENTION

### Field of Invention

The present invention is directed to an apparatus and method for applying a retarding force to a moving handrail of an escalator or moving walkway and collecting data to document testing of the handrail for compliance with safety regulations or protocols such as ASME A17.1/CSA B44.1, Safety Code for Elevators and Escalators.

### Description of the Background Art

The 2014 Release of ASME A17.1/CSA B44.1 established a requirement that when a retarding force is applied to an operating escalator or moving walkway handrail, the speed of the handrail must not change. Section 6.1.3.4.1 provides each balustrade shall be provided with a handrail moving in the same direction and at substantially the same speed as the steps. In the case of curved escalators, this shall be substantially the same angular velocity. The speed of the handrail shall not change when a retarding force of 450N (100 lbf) is applied to the handrail opposite to the direction of travel. Section 6.2.3.4.1 provides each balustrade shall be provided with a handrail moving in the same direction and at substantially the same speed as the treadway. The speed of the handrail shall not change when a retarding force of 450 N (100 lbf) is applied to the handrail opposite to the direction of travel.

In addition, it is required that this property of the operating handrail system is tested at the time of commissioning of new or altered escalators and moving walks. See section 8.10.4.1.1 (c)(1) and (7) and annually as part of the Category 1 test defined by section 8.6.8.15.13.

The maintenance provider is also responsible to define a written testing procedure to perform this test. This procedure is to be left on site as part of the on-site documentation required by section 8.6.1.2.2 (d)(7).

Proposed solutions utilize devices that slide friction materials against the handrail to generate a retarding force, or others that utilize a fixed cross-section tensile specimen connected between the equipment handrail and a stationary point. When the tensile specimen breaks at 100 lbf and the handrail does not slip is considered by some inspectors as compliance. Each of these solutions present issues ranging from damage to the handrail and/or injury of the technician or the inspector when the tensile specimen fractures. Exemplary embodiments of the invention provide a safe means to conduct this test on an operating escalator or moving walkway without damaging the equipment or placing the technician in harm’s way, as well as documenting the testing results.

### SUMMARY OF THE INVENTION

Exemplary embodiments of the invention provide a moving handrail impedance tool for testing an escalator or moving walkway. The moving handrail impedance tool may include a main frame and a first wheel assembly mounted on the main frame. The first wheel assembly may include a first contact wheel having a handrail contact surface for contacting a first side of the handrail and a second contact wheel having a handrail contact surface for contacting the first side of the handrail. A first brake is provided to impede rotation of the first contact wheel and the second contact wheel caused by contact of the first contact wheel and the second contact wheel with the first side of the handrail when it is moving. A second wheel assembly may be mounted on the main frame. The second wheel assembly may include a third contact wheel having a handrail contact surface for contacting a second side of the handrail, opposite the first side of the handrail and a fourth contact wheel having a handrail contact surface for contacting the second side of the handrail. A second brake is provided to impede rotation of the third contact wheel and the fourth contact wheel caused by contact of the third contact wheel and the fourth contact wheel with the second side of the handrail when it is moving.

In an exemplary embodiment of the invention, a brake control may be mounted on the main frame. The brake control allows a user to apply the first brake to the first contact wheel and the second contact wheel for applying a force to the first side of the handrail and for applying the second brake to the third contact wheel and the fourth contact wheel to apply a force to the second side of the handrail to impede travel of the handrail when it is moving.

In an exemplary embodiment of the moving handrail impedance tool according to the invention, the first brake may include a first rotor fixed to rotate with the first contact wheel and a first caliper for applying a frictional force to the first rotor. The second brake may include a second rotor fixed to rotate with the third contact wheel and a second caliper for applying a frictional force to the second rotor, wherein the brake controller may be a hydraulic actuator operable by a user to apply a hydraulic force to the first and second calipers.

In an exemplary embodiment of the invention, a front guide may be mounted on a load side of the main frame. The front guide may include a vertical support roller configured to ride on a surface of the handrail. A force sensor may be provided to be attached to a fixed reaction point on the moving handrail system to measure a load applied to the handrail by the first through fourth contact wheels. A speed sensor may be provided to measure a handrail speed vs time.

In an exemplary embodiment of the invention, an adjuster may be located on the main frame. The adjuster allows a user to adjust the first wheel assembly and second wheel assembly in opposite directions for widening and narrowing a width of a space between the first wheel assembly and the second wheel assembly for mounting the first and second wheel assemblies on the handrail with the handrail located between the first and second wheel assemblies.

In an exemplary embodiment of the invention, the adjuster may include a threaded rod and a knob operable by a user to rotate the threaded rod. The adjuster may include at least two first arms configured to move away from and toward the main frame by rotation of the threaded rod. At least the two first arms are connected to the first wheel assembly. At least two second arms are provided to move away from and toward the main frame by rotation of the threaded rod. At least the two second arms are connected to the second wheel assembly.

In an exemplary embodiment of the invention, a controller is provided and configured to receive an input from the force sensor and the speed sensor and to control a display to show the handrail speed and the load versus time applied to the handrail by the first through fourth contact wheels.

In an exemplary embodiment the display includes a user interface configured to receive an instruction from a user to begin a test operation.

In an exemplary embodiment a battery may be included to provide power to the controller and the display.

In an exemplary embodiment of the invention, the controller is a processor coupled to a memory. The processor may be configured to record the handrail speed and the load versus time applied to the handrail. The processor may include a data port configured to transmit and receive data including handrail speed and the load versus time applied to the handrail.

In an exemplary embodiment of the invention, a transmitter is provided to transmit the data.

In an exemplary embodiment of the invention, the front guide includes a first pivot configured to adjust an alignment of the force sensor in a first axis and a second pivot configured to adjust an alignment of the force sensor on a second axis perpendicular to the first axis.

In an exemplary embodiment of the invention, each of the first through fourth contact wheels has a circumferential groove configured to accommodate the handrail.

In an exemplary embodiment of the invention, the first contact wheel and the second contact wheel may be linked to rotate together so that a braking force acting on the first contact wheel also acts to impede rotation of the second contact wheel. The third contact wheel and the fourth contact wheel may be linked to rotate together so that a braking force acting on the third contact wheel also acts to impede rotation of the fourth contact wheel.

In an exemplary embodiment of the invention, the vertical support roller is configured to be adjustable to ride on a surface of the handrail for preventing tipping of the device. The vertical support roller may include the speed sensor for providing the handrail speed.

In an exemplary embodiment of the invention, the first to fourth contact wheels are formed of a material such as polyurethane having a coefficient of friction sufficient to provide at least 100 lbf without slipping on the moving handrail.

In an exemplary embodiment of the invention, a cover may be provided to cover the various operating parts of the tool. The cover may include a first side having a first side wall extending in a direction of arrangement of the first contact wheel and the second contact wheel and a second side wall having a first cutout. The first side may include a third side wall extending parallel to the second side wall and having a second cutout, a first top wall and an open bottom, opposite the first top wall, for receiving the first and second wheel assemblies. The cover may include a second side having a fourth side wall extending in a direction of arrangement of the third contact wheel and the fourth contact wheel and a fifth side wall having a third cutout. The second side may include a sixth side wall extending parallel to the fifth side wall and having a fourth cutout, a second top wall including a display, and an open bottom, opposite the second top wall, for receiving the third and fourth wheel assemblies. The first side wall may abut the fifth side wall. The first cutout and the third cutout define an access hole for the adjuster. The second side wall may abut the sixth side wall. The second cutout and the fourth cutout define an access hole for the front guide and the first top wall abuts the second top wall.

An exemplary embodiment of the invention may include a reaction point frame. The reaction point frame includes at least one clamp configured to be mounted to a fixed portion of a moving handrail system that includes the handrail and a coupler configured to attach the reaction point frame to the front guide.

In an exemplary embodiment of the invention, the reaction point frame may include a vertical frame configured to have an adjustable height. A base of the vertical frame may include a first clamp. The first clamp may be mounted on an access cover frame of the moving handrail system. A diagonal frame may be pivotally attached to the vertical frame at a first end. A second end of the diagonal frame, opposite the first end, may include a second clam. The second clamp may be mounted on the access cover frame of the moving handrail system upstream in a handrail moving direction, of the first clamp. The coupler may include a tether. The tether may be attached at a first end to the vertical frame and may be attached at a second end to the front guide, The tether may have an adjustable length.

In an exemplary embodiment of the invention, the clamps may include a plate that may be rotatably attached to the base of at least one of the vertical frame and the diagonal frame. The plate may be attached to the access cover frame.

An exemplary embodiment according to the invention may include a method of testing a moving walkway using the moving handrail impedance tool, the moving handrail impedance tool including a main frame and a first wheel assembly mounted on the main frame. The first wheel assembly may include a first contact wheel having a handrail contact surface for contacting a first side of the handrail and a second contact wheel having handrail contact surface for contacting the first side of the handrail. A first brake is provided to impede rotation of the first contact wheel and the second contact wheel caused by contact of the first contact wheel and the second contact wheel with the first side of the handrail when it is moving. A second wheel assembly may be mounted on the main frame. The second wheel assembly can include a third contact wheel having a handrail contact surface for contacting a second side of the handrail, opposite the first side of the handrail and a fourth contact wheel having a handrail contact surface for contacting the second side of the handrail. A second brake is provided to impede rotation of the third contact wheel and the fourth contact wheel caused by contact of the third contact wheel and the fourth contact wheel with the second side of the handrail when it is moving. A brake adjuster may be mounted on the main frame. The brake adjuster is provided to allow a user to apply the first brake to the first contact wheel and the second contact wheel for applying a force to the first side of the handrail and for applying the second brake to the third contact wheel and the fourth contact wheel to apply a force to the second side of the handrail to impede travel of the handrail when it is moving. A front guide is mounted on the load side of the main frame. The front guide may include a vertical support roller configured to ride on the top surface of the handrail. A force sensor is provided to be attached to a fixed reaction point on the moving handrail system to measure a load applied to the handrail by the first through fourth contact wheels. A speed sensor is provided to measure a handrail speed vs time.

The method of testing an escalator or moving walkway may include mounting the moving handrail impedance tool on the handrail of the escalator or moving walkway with the first and second contact wheels on the first side of the handrail and the third and fourth contact wheels on the second side of the handrail, adjusting knob and threaded rod to move the first wheel assembly and the second wheel assembly so that the first and second contact wheels contact the first side of the handrail and the third and fourth contact wheels contact the second side of the handrail, connecting the front guide to a fixed reaction point to prevent movement of the moving handrail impedance tool, activating the escalator or moving walkway so that the handrail is moving, applying a braking force using the brake adjuster to the first and second contact wheels on the first side of the handrail and the third and fourth contact wheels on the second side of the handrail to impede movement of the handrail, and measuring the handrail speed and the applied impeding force for a predetermined time after the braking force has been applied.

The method of testing an escalator or moving walkway using a moving handrail impedance tool according to an exemplary embodiment of the invention may include mounting a reaction point frame to a fixed point to form the fixed reaction point.

The method of testing an escalator or moving walkway using a moving handrail impedance tool according to an exemplary embodiment according to the invention includes adjusting the knob so that the wheels in the first wheel assembly and the second wheel assembly contact the surface of the handrail and apply a braking force so that the first and second contact wheels contact the first side of the handrail and the third and fourth contact wheels contact the second side of the handrail with an impedance force, opposite to a moving handrail driving force, of at least 100 lbf.

Further scope of applicability of the invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1A is a side view of a moving handrail impedance tool with the housing according to an exemplary embodiment of the disclosure;

FIG. 1B is a plan view of the moving handrail impedance tool with the housing of FIG. 1A;

FIG. 2 is a perspective view of the moving handrail impedance tool with the housing removed;

FIG. 3A is a detail view of the display arranged on the housing;

FIG. 3B is a view of the control systems according to an exemplary embodiment of the disclosure;

FIG. 4 is an assembly view of the moving handrail impedance tool with the housing;

FIG. 5 is an exploded assembly view of the moving handrail impedance tool;

FIG. 6A is a perspective view of an adjuster of the moving handrail impedance tool;

FIG. 6B is an assembly view of the adjuster with the knob and threaded rod of the moving handrail impedance tool;

FIG. 7 is an assembly view of one of the wheel assemblies of the moving handrail impedance tool;

FIG. 8 is a perspective view of a brake system of the moving handrail impedance tool;

FIG. 9 is a perspective view of a fixed reaction point frame tethered to the moving handrail impedance tool; and

FIG. 10 is a perspective view of a fixed reaction point frame tethered to the moving handrail impedance tool.

### DETAILED DESCRIPTION OF THE PREFERRED EMBODIMENTS

The disclosure of which described above is not limited to the materials and features described therein, and may be changed within the scope of one ordinary skill in the art.

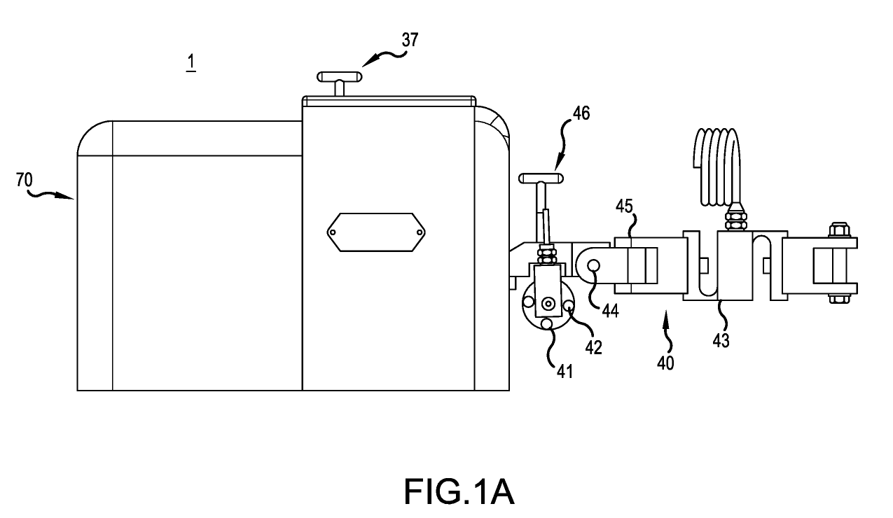

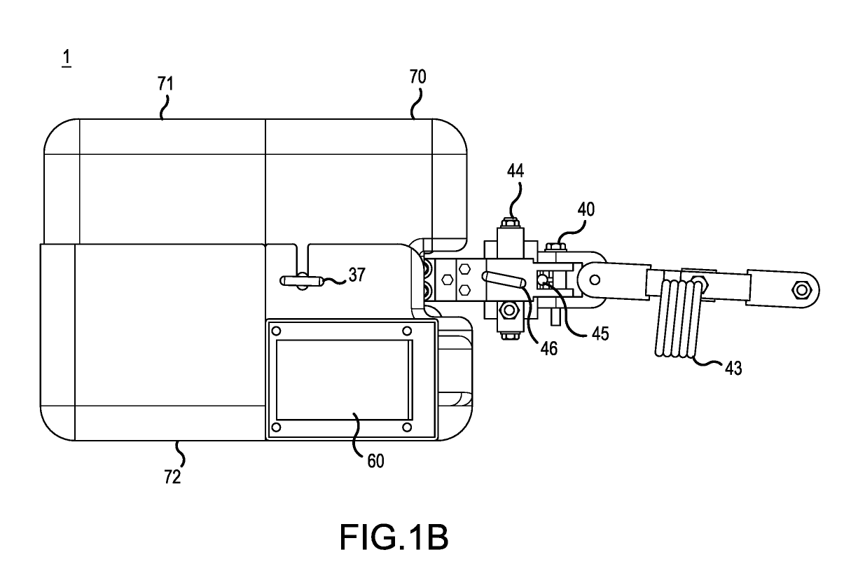

FIG. 1A is a view of a moving handrail impedance tool 1 according to an exemplary embodiment of the disclosure. In FIG. 1A the cover 70 houses the operable moving parts of the moving handrail impedance tool 1. This protects the user from the moving parts, prevents dirt and dust from settling on the moving handrail impedance tool 1, and allows for easier transport of the tool by the user. The front guide 40 is arranged downstream in a moving handrail direction.

FIG. 1B is a plan view of the moving handrail impedance tool 1 according to an exemplary embodiment of the disclosure. In FIG. 1B the cover 70 is shown with first side 71 and second side 72 which are configured to fit together to form the entire cover 70.

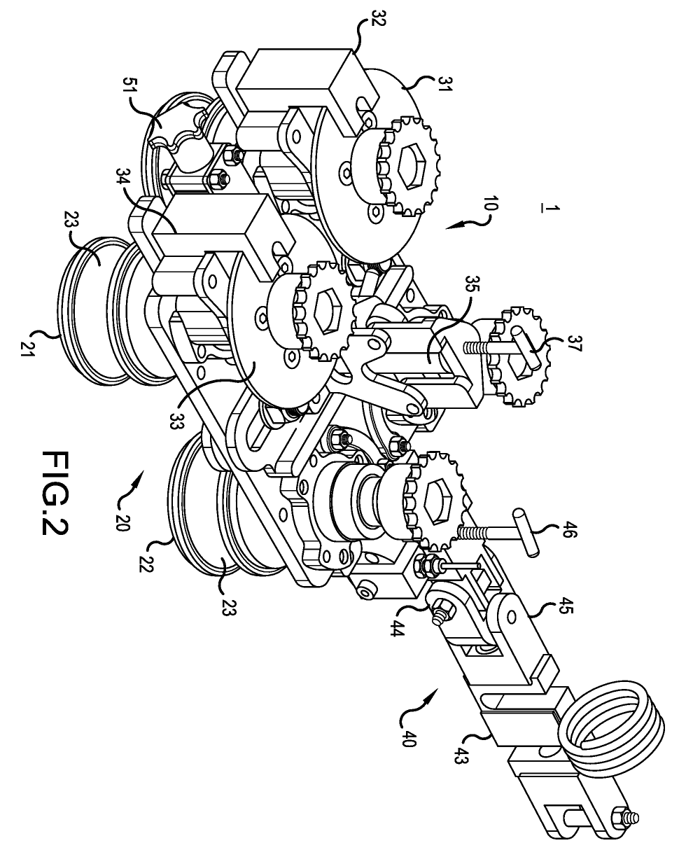

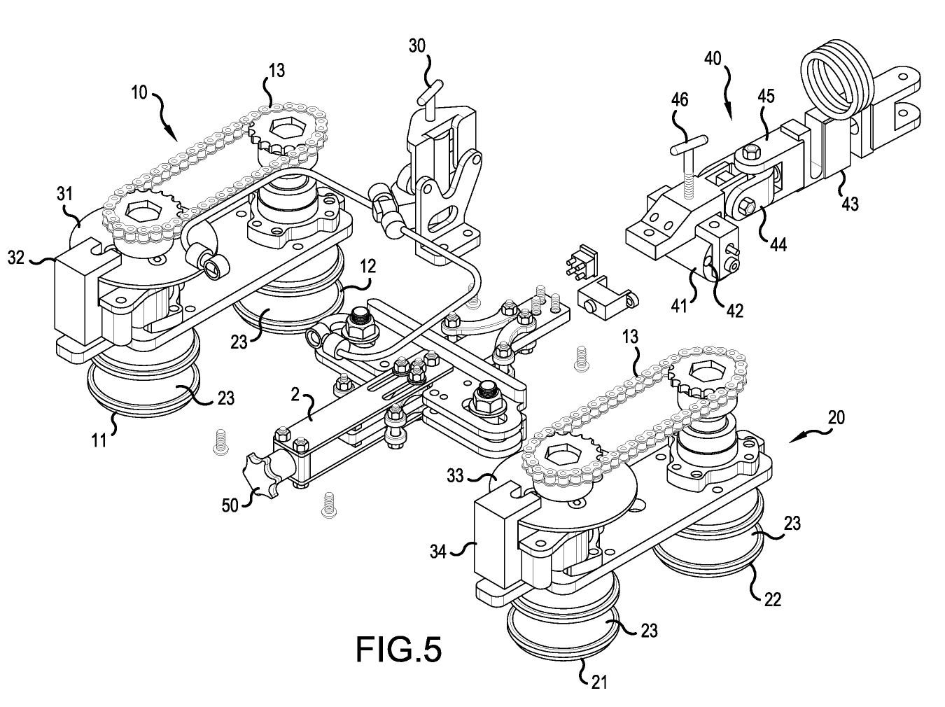

FIG. 2 is a perspective view of an exemplary embodiment of the moving handrail 3 impedance tool 1 with the housing 70 removed. The moving handrail impedance tool 1 includes a main frame 2, as shown in FIG. 5 and a first wheel assembly 10 mounted on the main frame 2. The first wheel assembly 10 includes a first contact wheel 11, as shown in FIG. 5, having a handrail contact surface 23 for contacting a first side of the handrail 3 and a second contact wheel 12 having handrail contact surface for contacting the first side of the handrail 3. A first brake is provided to impede rotation of the first contact wheel 11 and the second contact wheel 12 caused by contact of the first contact wheel 11 and the second contact wheel 12 with the first side of the handrail 3 when it is moving. A second wheel assembly 20 is mounted on the main frame 2. The second wheel assembly 20 includes a third contact wheel 21 having a handrail contact surface for contacting a second side of the handrail 3, opposite the first side of the handrail 3 and a fourth contact wheel 22 having a handrail contact surface for contacting the second side of the handrail 3. A second brake is provided to impede rotation of the third contact wheel 21 and the fourth contact wheel 22 caused by contact of the third contact wheel 21 and the fourth contact wheel 22 with the second side of the handrail 3 when it is moving.

The number of contact wheels is not particularly limited and may include any suitable number that is able to provide an impedance force of at least 100 lbf, opposite to a moving handrail driving force. According to an exemplary embodiment of the invention, each of the first through fourth contact wheels 11, 12, 21, 22 has a circumferential groove 23 configured to accommodate the handrail 3. In an exemplary embodiment according to the invention, the first to fourth contact wheels are formed of a polyurethane having a coefficient of friction sufficient to provide at least 100 lbf without slipping on the moving handrail 3. The material forming the contact wheels 11, 12, 21, 22 is not particularly limited but may be chosen based on parameters including being able to provide at least 100 lbf without slipping on the moving handrail 3, limiting damage to the handrail 3, cost considerations and weight considerations.

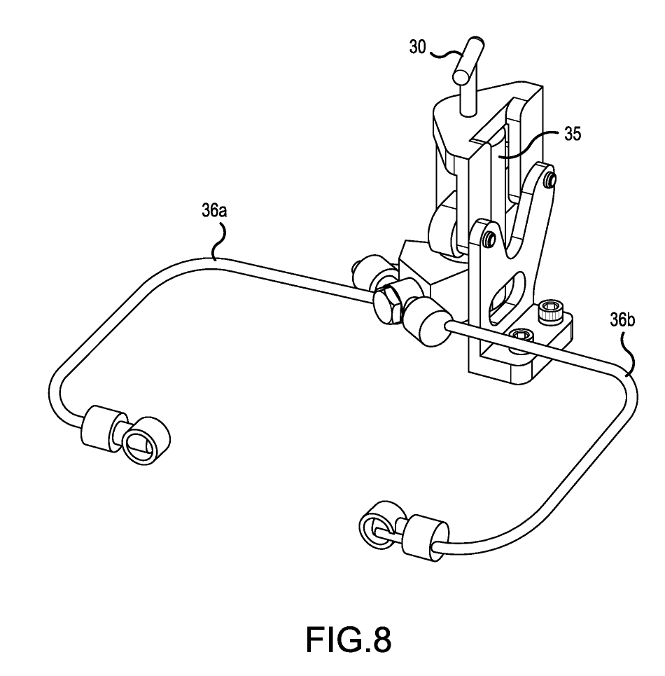

In an exemplary embodiment of the moving handrail impedance tool according to the invention, as shown in FIG. 2, the first brake may include a first rotor 31 fixed to rotate with the first contact wheel 11 and a first caliper 32 for applying a frictional force to the first rotor 31. The second brake may include a second rotor 33 fixed to rotate with the third contact wheel 21 and a second caliper 34 for applying a frictional force to the second rotor 31. In an exemplary embodiment of the invention as shown in FIG. 8, the brake 30 may include a hydraulic actuator including a master cylinder 35 operable by a user through a brake controller 37, such as a handle, to apply a hydraulic force through brake lines 36a, 36b to the first and second calipers 32, 34. In an exemplary embodiment of the invention the brake adjuster 30 can be electric or any other suitable device for operating on the contact wheels to apply an impedance force of at least 100 lbf.

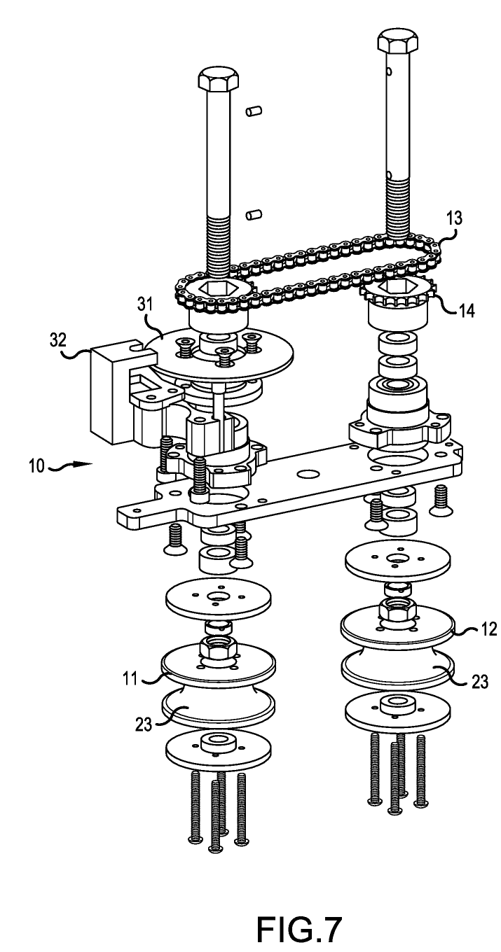

In an exemplary embodiment of the invention, as shown in FIG. 7, the first contact wheel 11 and the second contact wheel 12 are linked to rotate together so that a braking force acting on the first contact wheel 11 also acts to impede rotation of the second contact wheel 12. The third contact wheel 21 and the fourth contact wheel 22 are linked to rotate together so that a braking force acting on the third contact wheel 21 also acts to impede rotation of the fourth contact wheel 22. In an exemplary embodiment of the invention the first contact wheel 11 and the second contact wheel 12 are linked to rotate together by a roller chain 13 with a roller chain sprocket 14 mounted on each of the first contact wheel 11 and the second contact wheel 12. The third contact wheel 21 and the fourth contact wheel 22 are similarly linked. The means of linking the contact wheels is not particularly limited and a belt or any other means providing sufficient frictional force may be used in place of a roller chain 13.

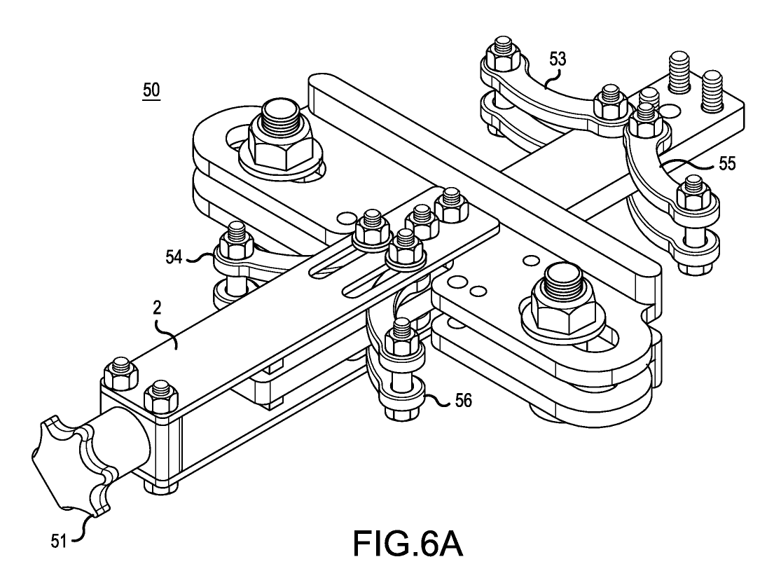

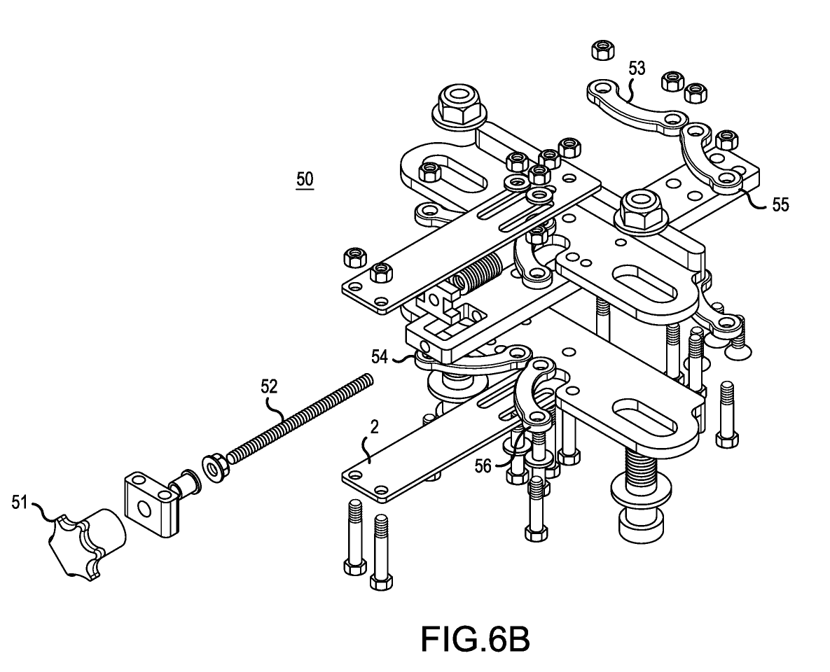

In an exemplary embodiment of the invention an adjuster 50 may be used to adjust the first wheel assembly 10 and the second wheel assembly 20 so that the first and second contact wheels 11, 12 contact the first side of the handrail 3 and the third and fourth contact wheels 21, 22 contact the second side of the handrail 3. As shown in FIGS. 6A and 6B, the adjuster 50 includes a threaded rod 52 and a knob 51, operable by a user to rotate the threaded rod 52. The adjuster 50 shall include at least two first arms 53, 54 configured to move away from and toward the main frame 2 by rotation of the threaded rod 52. At least two first arms 53, 54 are connected to the first wheel assembly 10. At least two second arms 55, 56 are provided to simultaneously with the at least two first arms 53, 54, move away from and toward the main frame 2 by rotation of the threaded rod 52. The at least two second arms 55, 56 are connected to the second wheel assembly 20. The moving handrail impedance tool 1 is mounted on the handrail 3 of the moving walkway by a user turning the knob 51 in a first direction to turn the threaded rod 52 to operate the arms 53, 54 on the first wheel assembly 10 and to operate the at least two second arms 55, 56 on the second wheel assembly 20 so that the first wheel assembly 10 and the second wheel assembly 20 move apart from each other. When a space between the first wheel assembly 10 and the second wheel assembly 20 is sufficient to accommodate the handrail 3, the user may turn the knob 51 in a second direction, opposite to the first direction, to turn the threaded rod 52 to operate the arms 53, 54 on the first wheel assembly 10 and to simultaneously operate the arms 55, 56 on the second wheel assembly 20, so that the first wheel assembly 10 and the second wheel assembly 20 move towards each other and come in contact with respective first and second sides of the handrail.

As shown in FIG. 5, in an exemplary embodiment of the invention, a front guide 40 is mounted on a load side of the main frame 2. The front guide 40 includes an adjustable vertical support roller 41 configured to ride on the top surface of the handrail 3. A force sensor 43 is provided to be attached to a fixed reaction point on the moving handrail system to measure a load applied to the handrail 3 by the first through fourth contact wheels 11, 12, 21, 22. The force sensor 43 may be a tension/compression load cell mounted in series with the moving handrail impedance tool and a fixed reaction point to be described later. A speed sensor 42 is provided to measure a handrail speed vs time. The type of force sensor 43 and the speed sensor 42 are not particularly limited and can be any suitable force sensor and the speed sensor.

As shown in an exemplary embodiment of the invention in FIG. 5, the vertical support roller 41 is configured to be adjustable via handle 46 to ride on a surface of the handrail 3 for preventing tipping of the device. The vertical support roller 41 may include the speed sensor 42 for providing handrail speed. In an exemplary embodiment of the invention the speed sensor 42 includes 4 steel pins mounted in the vertical support roller and arranged to be detected by a proximity sensor to provide data on a speed of the handrail 3 during testing.

In an exemplary embodiment of the invention, the front guide 40 includes a first pivot 44 configured to adjust an alignment of the force sensor 43 in a first axis and a second pivot 45 configured to adjust an alignment of the force sensor 43 on a second axis perpendicular to the first axis.

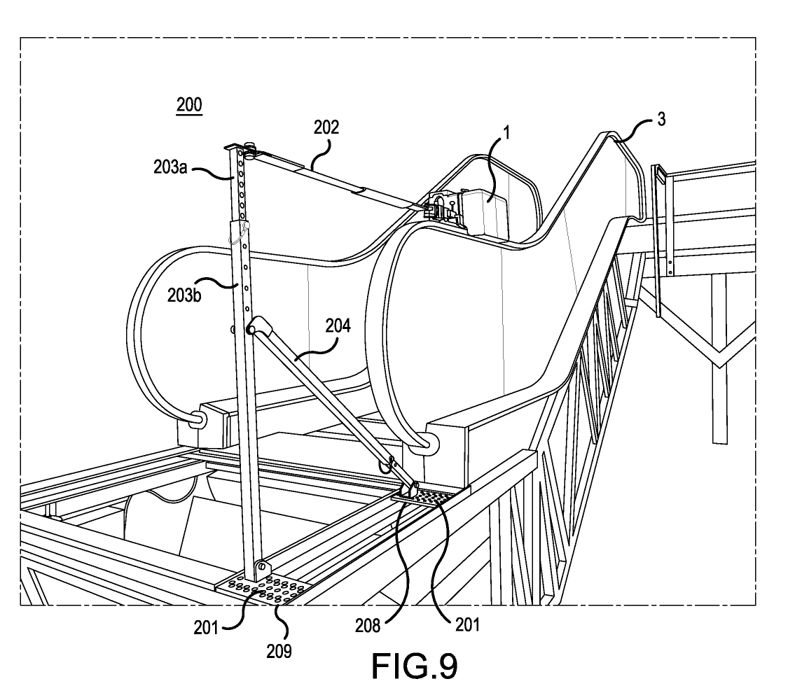

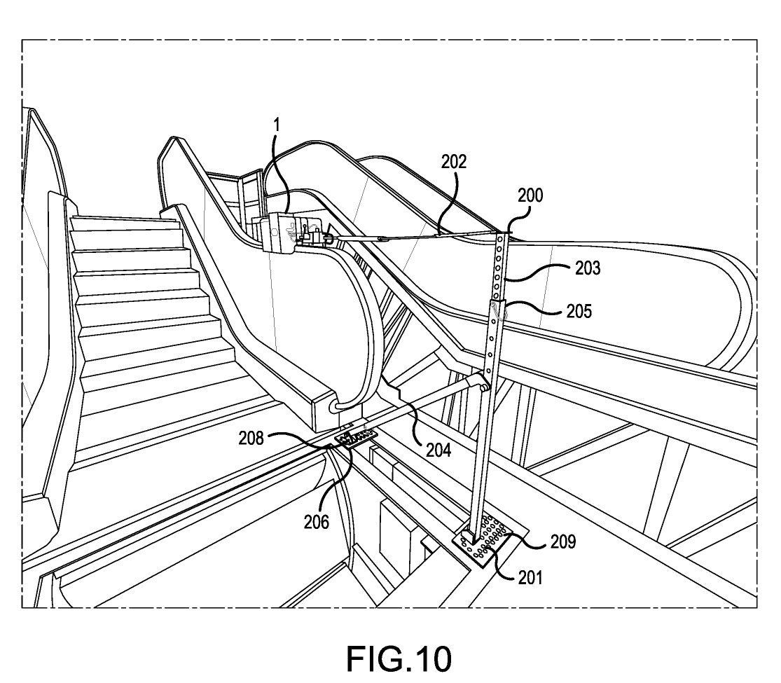

As shown in FIGS. 9 and 10, an exemplary embodiment of the moving handrail impedance tool according to the invention may include a reaction point frame 200. The reaction point frame 200 includes at least one clamp 201, 206 configured to be mounted to a fixed portion of a moving handrail system that includes the handrail 3. The reaction point frame 200 includes a coupler 202 configured to attach the reaction point frame to the front guide 40 via a tether 207.

In an exemplary embodiment of the invention, the reaction point frame 200 includes a vertical frame 203 configured to have an adjustable height. In an exemplary embodiment, the vertical frame 203 can have an outer vertical beam 203a and an inner vertical beam 203b. The inner vertical beam 203b can slide inside the outer vertical beam 203a. By matching through holes arranged in the inner vertical beam 203b and through holes arranged in the outer vertical beam 203a and securing a pin 205 that passes through the matched holes, the height of the vertical frame 203 can be adjusted to match the height of the mounted front guide 40. The coupler 200 is attached to one end of the inner vertical beam 203b.

A base of the vertical frame 203 includes a first clamp 201. The first clamp 201 may be mounted on an access cover frame of the moving handrail system. A diagonal frame 204 may be pivotally attached to the vertical frame 203 at a first end. A second end of the diagonal frame 204, opposite the first end, includes a second clamp 206. The second clamp 206 is mounted on the access cover frame of the moving handrail system upstream, in a handrail moving direction, of the first clamp 201. The tether 202 is attached at a first end to the vertical frame 203 and attached at a second end to the front guide 40 so as to be in series with the moving handrail impedance tool 1 and the reaction point frame 200 aligned in a direction of movement of the handrail 3. The tether 202 may have an adjustable length. The tether 202 may be formed of any suitable material including leather and reinforced rubber. The tether 202 includes connectors such as a hook arranged at a first end and a second end to attach the tether to the front guide 40 and the vertical frame 203. There is no particular limitation as to the type of the connector as long as the tether is securely fixed, can transmit and withstand the tensile forces and is arranged in series with the moving handrail impedance tool 1 and the reaction point frame 200 aligned in a direction of movement of the handrail 3.

In an exemplary embodiment of the moving handrail impedance tool according to the invention the clamps 201, 206 may include a plate 208, 209 that may be rotatably attached to the base of the vertical frame 203 and the diagonal frame 204. The plates 208, 209 may be attached to the access cover frame of the moving walkway.

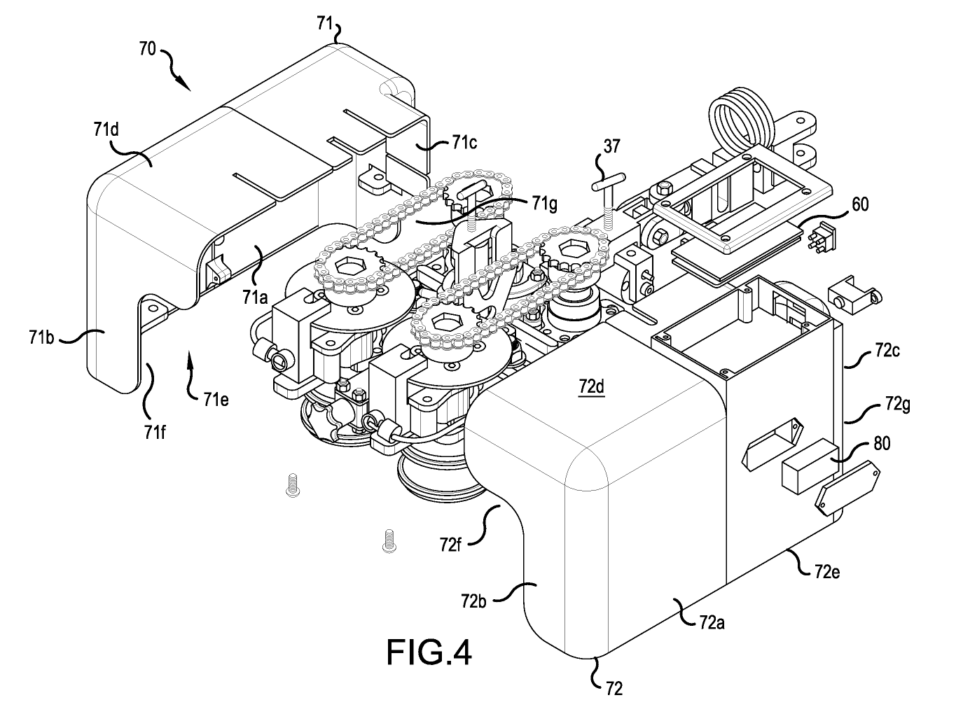

As show in FIG. 4, the moving handrail impedance tool according to an exemplary embodiment of the invention may include the cover 70 to surround the moving portions of the tool. The cover 70 protects the user from the moving portions while in operation, protects the moving portions against dirt or dust and eases transport of the tool by the user. The cover 70 allows the tool to be mounted on the moving handrail 3 without the need to remove the cover 70. The cover 70 may include the first side 71 having a first side wall 71a extending in a direction of arrangement of the first contact wheel 10 and the second contact wheel 11 and a second side wall 71b having a first cutout 71f. The first side 71 includes a third side wall 71c extending parallel to the second side wall 71b and having a second cutout 71g. A first top wall 71d connects the first side wall 71a, the second side wall 71b and the third side wall 71c. The first side 71 has a first open bottom 71e, opposite the first top wall 71d, for receiving the first and second contact wheels 10, 20. The cover 70 may include the second side 72 having a fourth side wall 72a extending in a direction of arrangement of the third contact wheel 21 and the fourth contact wheel 22 and a fifth side wall 72b having a third cutout 72f. The second side 72 includes a sixth side wall 72c extending parallel to the fifth side wall 72b and having a fourth cutout 72g. A second top wall 72d includes a display 60. The cover 72 has a second open bottom 72e, opposite the second top wall 72d, for receiving the third and fourth contact wheels 21, 22. The first side 71 and the second side 72 may be separate pieces assembled to define the cover 70. The second side wall 71b abuts the fifth side wall 72b. The first cutout 71f and the third cutout 72f define an access hole for the adjuster 50. The third side wall 71c abuts the sixth side wall 72c. The second cutout 71g and the fourth cutout 72g define an access hole for the front guide 40. The first top wall 71d abuts the second top wall 72d. The open bottoms 71e and 72e allow the tool to be mounted on the moving handrail with the cover 70 in place. The access holes allow the moving handrail 3 to pass through the cover to the operational part of the tool.

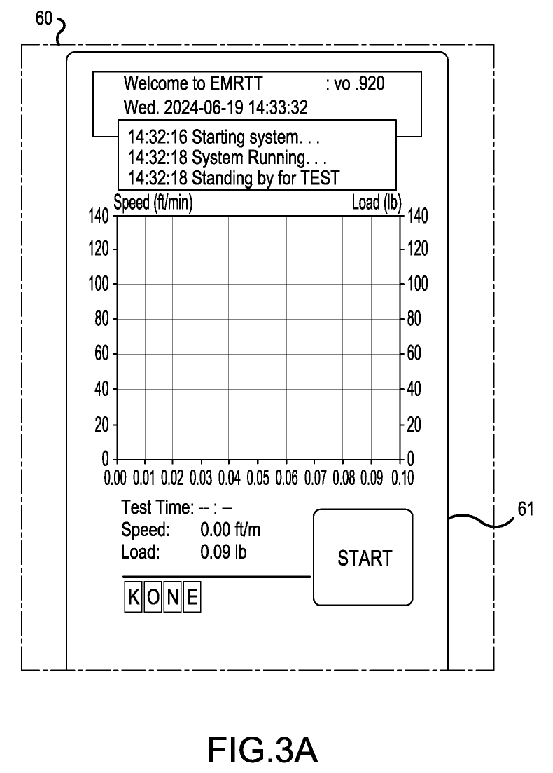

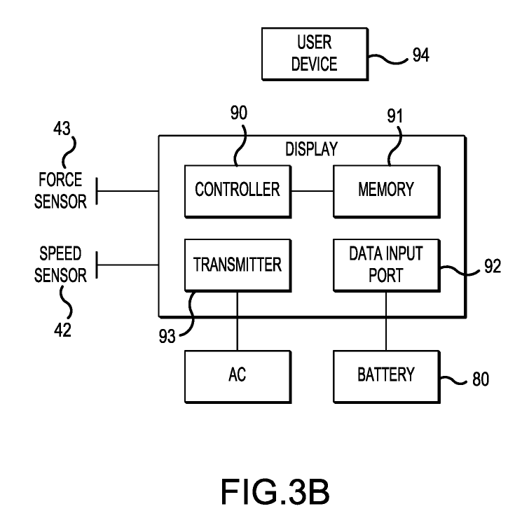

The display 60 according to an exemplary embodiment of the invention shown in FIG. 3A shows at least the handrail speed vs time and the load applied to the handrail 3 by the first through fourth contact wheels. FIG. 3B shows an exemplary embodiment of a controller 90 that receives an input from the force sensor 43 and the speed sensor 42 and controls the display 60 to show the handrail speed vs time and the load applied to the handrail 3 by the first through fourth contact wheels 11, 12, 21, 22. In an exemplary embodiment of the invention the display 60 includes a user interface 61 for receiving an input instruction from a user to begin a test operation by providing power to the controller 90 and the display 60. In an exemplary embodiment of the invention the controller 60 may be operated by a remote user device 94 such as a dedicated device or a personal device such as smart phone or pad with an application.

The display 60 and controller 90 can be powered by a battery 80 that is replaceable or rechargeable and/or powered by being directly plugged into a power source.

The controller according to an exemplary embodiment of the invention is hardware able to execute algorithms to perform the needed functions. The controller may be any suitable hardware, such as a printed circuit board, or a processor, such as a micro-processor, coupled to a memory. The processor may be configured to record the handrail speed vs time and the load applied to the handrail 3. The processor may include a data port 92 configured to transmit and receive data including handrail speed vs time and the load applied to the handrail 3 to a user device for recording and reporting the results of the test. According to an exemplary embodiment of the invention, the processor may transmit the data via a transmitter 93 to a user device 94 such as a smart phone or pad. The data may also be transmitted directly to an owner of the escalator or moving walkway or an agency that monitors the testing through an application in the processor or in the user device.

A method of testing an escalator or moving walkway using the moving handrail impedance tool according to the exemplary embodiments of the invention will now be described. A user will mount the moving handrail impedance tool on the handrail 3 of the moving walkway with the first and second contact wheels 11, 12 on a first side of the handrail 3 and the third and fourth contact wheels 21, 22 on a second side of the handrail 3. The user adjusts the first wheel assembly 10 and the second wheel assembly 20 so that the first and second contact wheels 11, 21 contact the first side of the handrail 3 and the third and fourth contact wheels 21, 22 contact the second side of the handrail 3. The reaction point frame 200 is mounted to a fixed portion of a moving handrail system that includes the handrail 3. The reaction point frame 200 is attached to the front guide 40 via the tether 202 so that the reaction point frame 200, the front guide 40 and the moving handrail impedance tool 1 are all serially aligned. The moving walkway is activated. The user applies a braking force using the brake control 37 to the first and second contact wheels 11, 12 on the first side of the handrail 3 and the third and fourth contact wheels 21, 22 on the second side of the handrail 3 to impede movement of the handrail 3 so that the first and second contact wheels contact the first side of the handrail 3 and the third and fourth contact wheels contact the second side of the handrail 3 with an impedance force of at least 100 lbf, substantially normal (0-15%) to the moving direction of the handrail 3, and in an opposite to a moving handrail driving force. The handrail speed and the applied impeding force are measured for a predetermined time after the braking force has been applied. In an exemplary embodiment the predetermined time is 2 minutes, but any relevant period of time may be used.

Although the exemplary embodiments of the present disclosure have been described in detail with reference to the accompanying drawings, the present disclosure is not limited thereto and can be embodied in many different forms without departing from the technical concept of the present disclosure. Therefore, the exemplary embodiments of the present disclosure are provided for illustrative purposes only but not intended to limit the technical concept of the present disclosure. The scope of the technical concept of the present disclosure is not limited thereto. Therefore, it should be understood that the above-described example embodiments are illustrative in all aspects and do not limit the present disclosure.

The protective scope of the present disclosure should be construed based on the following claims, and all the technical concepts in the equivalent scope thereof should be construed as falling within the scope of the present disclosure.

What is claimed is:

1. A moving handrail impedance tool for testing an escalator or moving walkway, comprising:
a main frame;
a first wheel assembly mounted on the main frame, the first wheel assembly including:
a first contact wheel having a handrail contact surface for contacting a first side of the handrail;
a second contact wheel having handrail contact surface for contacting the first side of the handrail; and
a first brake configured to impede rotation of the first contact wheel and the second contact wheel caused by contact of the first contact wheel and the second contact wheel with the first side of the handrail when it is moving;
a second wheel assembly mounted on the main frame, the second wheel assembly including:
a third contact wheel having a handrail contact surface for contacting a second side of the handrail, opposite the first side of the handrail;
a fourth contact wheel having a handrail contact surface for contacting the second side of the handrail; and
a second brake configured to impede rotation of the third contact wheel and the fourth contact wheel caused by contact of the third contact wheel and the fourth contact wheel with the second side of the handrail when it is moving;
a brake adjuster mounted on the main frame, the brake adjuster being configured to allow a user apply the first brake to the first contact wheel and the second contact wheel to apply a force to the first side of the handrail and to apply the second brake to the third contact wheel and the fourth contact wheel to apply a force to the second side of the handrail to impede travel of the handrail when it is moving:
a front guide mounted on a load side of the main frame, the front guide including;
a vertical support roller configured to ride on a top surface of the handrail;
a force sensor configured to be attached to a fixed reaction point on the moving handrail system to measure a load applied to the handrail by the first through fourth contact wheels; and
a speed sensor configured to measure a handrail speed vs time and; and
an adjuster located on the main frame, the adjuster configured to allow a user to adjust the first wheel assembly and second wheel assembly in opposite directions for widening and narrowing a width of a space between the first wheel assembly and the second wheel assembly for mounting the first and second wheel assemblies on the handrail with the handrail located between the first and second wheel assemblies.

2. The moving handrail impedance tool according to claim 1, wherein the first brake comprises:
a first rotor fixed to rotate with the first contact wheel; and
a first caliper for applying a frictional force to the first rotor,
wherein the second brake comprises:
a second rotor fixed to rotate with the third contact wheel; and
a second caliper for applying a frictional force to the second rotor, wherein the brake adjuster is a hydraulic actuator configured to apply a hydraulic force to the first and second calipers.

3. The moving handrail impedance tool according to claim 1, wherein the adjuster comprises:
a threaded rod;
a knob configured to rotate the threaded rod;
at least two first arms configured to move away from and toward the main frame by rotation of the threaded rod, the at least two first arms being connected to the first wheel assembly; and
at least two second arms configured to move away from and toward the main frame by rotation of the threaded rod, the at least two second arms being connected to the second wheel assembly.

4. The moving handrail impedance tool according to claim 1, comprising:
a display; and
a controller configured to receive an input from the force sensor and the speed sensor and control the display to show the handrail speed vs time and the load applied to the handrail by the first through fourth contact wheels.

5. The moving handrail impedance tool according to claim 4, wherein the display includes a user interface configured to receive an instruction from a user to begin a test operation.

6. The moving handrail impedance tool according to claim 5, comprising;
a battery configured to provide power to the controller and the display.

7. The moving handrail impedance tool according to claim 4, wherein the controller is a processor coupled to a memory, the processor configured to record the handrail speed vs time and the load applied to the handrail, the processor including a data port configured to transmit and receive data including handrail speed vs time and the load applied to the handrail.

8. The moving handrail impedance tool according to claim 5, comprising:
a transmitter configured to transmit the data.

9. The moving handrail impedance tool according to claim 1, wherein the front guide further includes:
a first pivot configured to adjust an alignment of the force sensor in a first axis; and
a second pivot configured to adjust an alignment of the force sensor on a second axis perpendicular to the first axis.

10. The moving handrail impedance tool according to claim 1, wherein each of the first through fourth contact wheels has a circumferential groove configured to accommodate the handrail.

11. The moving handrail impedance tool according to claim 1, wherein the first contact wheel and the second contact wheel are linked to rotate together so that a braking force acting on the first contact wheel also acts to impede rotation of the second contact wheel, and
wherein the third contact wheel and the fourth contact wheel are linked to rotate together so that a braking force acting on the third contact wheel also acts to impede rotation of the fourth contact wheel.

12. The moving handrail impedance tool according to claim 1, wherein the vertical support roller is configured to be adjustable to ride on a surface of the handrail for preventing tipping of the device, wherein the vertical support roller includes the speed sensor for providing handrail speed.

13. The moving handrail impedance tool according to claim 1, wherein the first to fourth contact wheels are formed of a polyurethane having a coefficient of friction sufficient to provide at least 100 lbf without slipping on the moving handrail.

14. The moving handrail impedance tool according to claim 3, comprising:
a cover including:
a first side having;
a first side wall extending in a direction of arrangement of the first contact wheel and the second contact wheel;
a second side wall having a first cutout;
a third side wall extending parallel to the second side wall and having a second cutout;
a first top wall including a display;
an open bottom, opposite the first top wall, for receiving the first and second wheel assemblies;
a second side having:
a fourth side wall extending in a direction of arrangement of the third contact wheel and the fourth contact wheel;
a fifth side wall having a third cutout;
a sixth side wall extending parallel to the fifth side wall and having a fourth cutout;
a second top wall;
an open bottom, opposite the second top wall, for receiving the third and fourth wheel assemblies;
wherein the first side wall abuts the fifth side wall and the first cutout and the third cutout define an access hole for the adjuster, the second side wall abuts the sixth side wall and the second cutout and the fourth cutout define an access hole for the sensor and the first top wall abuts the second top wall.

15. The moving handrail impedance tool according to claim 1, comprising:
a reaction point frame, wherein the reaction point frame includes;
at least one clamp configured to be mounted to a fixed portion of a moving handrail system that includes the handrail; and
a coupler configured to attach the reaction point frame to the front guide.

16. The moving handrail impedance tool according to claim 10, wherein the reaction point frame further includes:
a vertical frame configured to have an adjustable height, a base of the vertical frame including a first clamp of the at least one clamp, the first clamp configured to be mounted on an access cover frame of the escalator or moving walkway;
a diagonal frame pivotally attached to the vertical frame at a first end, a second end of the diagonal frame, opposite the first end, including a second clamp of the at least one clamp, the second clamp configured to mounted on the access cover frame of the escalator or moving walkway upstream in a handrail moving direction, of the first clamp;
wherein the coupler includes a tether, the tether being configured to be attached at a first end to the vertical frame and being configured to be attached at a second end to the front guide, wherein the tether is configured to have an adjustable length.

17. The moving handrail impedance tool according to claim 11, wherein each at least one clamp includes a plate configured to be rotatably attached to the base of at least one of the vertical frame and the diagonal frame, the plate being configured to be attached to the access cover frame.

18. A method of testing an escalator or moving walkway using a moving handrail impedance tool, the moving handrail impedance tool including
a main frame;
a first wheel assembly mounted on the main frame, the first wheel assembly including:
a first contact wheel having a handrail contact surface for contacting a first side of the handrail;
a second contact wheel having handrail contact surface for contacting the first side of the handrail; and
a first brake configured to impede rotation of the first contact wheel and the second contact wheel caused by contact of the first contact wheel and the second contact wheel with the first side of the handrail when it is moving;
a second wheel assembly mounted on the main frame, the second wheel assembly including:
a third contact wheel having a handrail contact surface for contacting a second side of the handrail, opposite the first side of the handrail;
a fourth contact wheel having a handrail contact surface for contacting the second side of the handrail; and
a second brake configured to impede rotation of the third contact wheel and the fourth contact wheel caused by contact of the third contact wheel and the fourth contact wheel with the second side of the handrail when it is moving;
a brake controller mounted on the main frame, the brake controller being configured to allow a user apply the first brake to the first contact wheel and the second contact wheel to apply a force to the first side of the handrail and to apply the second brake to the third contact wheel and the fourth contact wheel to apply a force to the second side of the handrail to impede travel of the handrail when it is moving:
a front guide mounted on a load side of the main frame, the front guide including;
a vertical support roller configured to ride on a surface of the handrail;
a force sensor configured to be attached to a fixed reaction point on the moving handrail system; and
a speed sensor configured to measure a handrail speed vs time and a load applied to the handrail by the first through fourth contact wheels; and
the method comprising;
mounting the moving handrail impedance tool on the handrail of the moving walkway with the first and second contact wheels on the first side of the handrail and the third and fourth contact wheels on the second side of the handrail;
adjusting the first wheel assembly and the second wheel assembly so that the first and second contact wheels contact the first side of the handrail and the third and fourth contact wheels contact the second side of the handrail;
connecting the front guide to a fixed reaction point to prevent movement of the moving handrail impedance tool;
activating the moving walkway so that the handrail is moving;
applying a braking force using the brake adjuster to the first and second contact wheels on the first side of the handrail and the third and fourth contact wheels on the second side of the handrail to impede movement of the handrail; and
measuring the handrail speed and the applied impeding force for a predetermined time after the braking force has been applied.

19. The method of testing a moving walkway using a moving handrail impedance tool according to claim 18, further comprising;
mounting a reaction point frame to a fixed point to form the fixed reaction point.

20. The method of testing a moving walkway using a moving handrail impedance tool according to claim 18, wherein
the first wheel assembly and the second wheel assembly are adjusted, and the braking force is applied so that the first and second contact wheels contact the first side of the handrail and the third and fourth contact wheels contact the second side of the handrail with an impedance force, opposite to a moving handrail driving force, of at least 100 lbf.
